(19) United States
(12) Patent Application Publication
(10) Pub. No.: US 2007/0131306 A1
(43) Pub. Date: Jun. 14, 2007

(54) Tool support device

(76) Inventor: Gregory S. Snider, Bel Air, MD (US)

Correspondence Address: THE BLACK & DECKER CORPORATION, 701 EAST JOPPA ROAD, TW199, TOWSON, MD, 21286, US

(21) Appl. No.: 11/298,272

(22) Filed: Dec. 9, 2005

(51) Int. Cl. B25H 1/00

(52) U.S. Cl. 144/286.1; 144/286.5

(57) ABSTRACT

A support stand for a tool such as a miter saw is disclosed. The stand includes legs, a beam supported by the legs, and a pair of tool support platforms that may be connected to the tool. The tool support platforms are configured to slide along the beam; moreover, they can be removed from the beam and placed on a supporting surface. Each platform may include a receptacle that engages a clip fastened to the beam. The clip engages the platform to prevent its movement along the beam. Each platform also includes a series of slots through which fasteners are inserted. The slots allow the fasteners to be repositioned so they can be aligned with the specific connection points on a variety of different tools (including tools of different manufacturers).

### FIELD OF THE INVENTION

The present invention relates to a support device and, more particularly, to a workbench that can support a power tool and a workpiece.

### BACKGROUND

It is common in the construction industry for users to bring their tools (e.g. power tools such as saws) to the work site. Thus, the users require a stable work surface at the work site to support the tools and enable their use on a workpiece. Preferably, the work surface is raised so that the user can comfortably use the tool on the workpiece. In addition, the work surface should also be portable so that it can be easily moved around the work site. In the past, users have disposed their tools on sheets of wood, which are, in turn, supported by two or more sawhorses. This arrangement, however, lacks the strength and stability for efficient operation; moreover, this arrangement creates safety concerns since the tool is not rigidly secured to the work surface. Accordingly, support stands or portable work benches have been proposed that permanently lock a tool to the work surface platform. These prior art solutions, however, do not provide a tool platform that is capable of being repositioned while connected to the work surface platform so that the tool can be moved without moving the workpiece. Other prior art solutions provide a platform supporting the tool which can be moved horizontally so that the power tool can be moved without moving the workpiece; however, they require that the user insert and slide the platform from the end of the workbench towards the desired position on the workbench. This makes the set up process complex and time consuming. In addition, these prior art work surface platforms can only be used as a work surface while connected to the workbench. A user can not remove the work surface platform from the support stand and set it on another supporting surface such as a table or the ground. The aforementioned prior art solutions, moreover, typically provide a work surface designed to connect to a specific tool configuration; consequently, the workbench may only be able to connect to a specific power tool produced by a specific manufacturer. If a power tool produced by another manufacturer is brought to the worksite, another workbench adapted to be used with that specific power tool would also need to be supplied.

### SUMMARY OF THE INVENTION

Accordingly, the present invention is directed toward a support device which is designed to operably receive a tool, e.g., a power tool such as a miter saw. The support device of the present invention may comprise legs, a beam supported by the legs, and tool support platforms that are removably connected to the beam. The tool support platforms may be repositionable along the beam—they include foot members that slidingly capture the beam. The support device of the present invention may also include a stabilizing mechanism that locks the tool support platforms in place and prevents them from sliding along the beam. The foot members of the tool support platforms, in addition to capturing the beam, are adapted to support the tool support platforms on a supporting surface such as a table or floor. The tool support platforms of the present invention may also be configured to receive tools having various connection point configurations. Specifically, the tool support platforms of the present invention may include a plurality of slots, each adapted to receive a fastener that engages a connection point of the particular tool to be mounted to the platform. The slots in the tool support platforms may be selectively utilized; in addition, the fasteners may be repositioned within the slots. This configuration enables a user to customize a secure connection for a particular tool to the tool support platforms of the present invention, accommodating the connection layouts of various tools, as well as the connection layouts of the same type of tools produced by different manufacturers.

### BRIEF DESCRIPTION OF THE DRAWINGS

FIG. 1 illustrates a perspective view of a support device according to an embodiment of the present invention.

FIG. 2 illustrates a close-up view of the support device of FIG. 1, showing the connection of the legs to the beam via a support bracket.

FIG. 3 illustrates a top view of the support device of FIG. 1 with a single tool support platform mounted thereto.

FIGS. 4A, 4B, and 4C illustrate perspective, close-up views of the support device of FIG. 1, showing a bracket coupled to a first workpiece support assembly, as well as the reorientation the first workpiece support assembly from a first position to a second position.

FIGS. 5A and 5B illustrate perspective views of the first workpiece support assembly of FIGS. 4A-4C, showing the reorientation of the first workpiece support assembly from a compact position to an expanded position.

FIGS. 6A and 6B illustrate perspective, close-up views of the support device of FIG. 1, showing a bracket coupled to a second workpiece support assembly, as well as the reorientation of the second workpiece support assembly from a compact position to an expanded position.

FIGS. 7A and 7B illustrate perspective, close-up views of the first workpiece support assembly of FIG. 4A, showing the repositioning of the first workpiece support assembly from a retracted position to an extended position.

FIGS. 8A and 8B illustrate perspective, close-up views of the second workpiece support assembly of FIG. 6A, showing the repositioning of the second workpiece support assembly from a retracted position to an extended position.

FIGS. 9A and 9B illustrate a front view of the support device of FIG. 1, showing the reorientation of the device from a retracted position to an extended position.

FIGS. 10A, 10B, 10C illustrate close-up views of the beam of the device of FIG. 1, showing the operation of an over-extension catch mechanism in accordance with an embodiment of the invention.

FIGS. 11A, 11B, 11C illustrate close-up views of the beam of the device of FIG. 1, showing the operation of the catch mechanism of FIG. 10.

FIGS. 12A and 12B illustrate bottom, perspective views of a tool support platform according to an embodiment of the invention.

FIG. 13 illustrates a close-up view of the support device of FIG. 1, showing the connection of the tool support platform to the beam.

Like reference numerals have been used to identify like elements throughout this disclosure.

### DETAILED DESCRIPTION

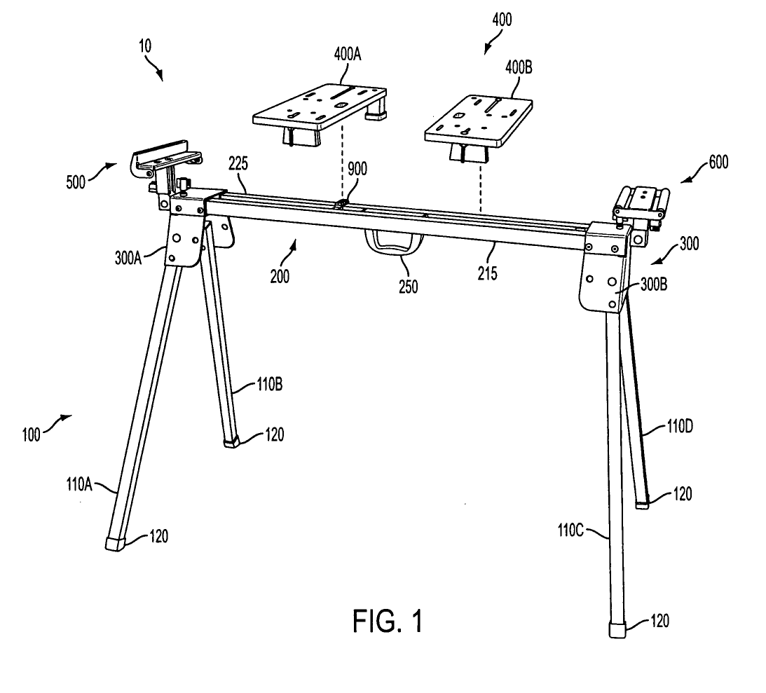

In accordance with the present invention, a support device or stand operable to support a tool and/or a workpiece is disclosed. FIG. 1 is a perspective view of a support device according to an embodiment of the present invention. As illustrated, the support device may comprise a workbench 10 including a base 100, a support beam assembly 200, brackets 300 connecting the beam assembly 200 to the base 100, and one or more tool support platforms 400. The base 100 comprises a structure configured to support the beam assembly 200 above a supporting surface (e.g., a floor or the ground). For example, the base 100 may comprise one or more support legs. In the embodiment illustrated in FIG. 1, the base 100 includes a first pair of legs 110A and 110B and a second pair of legs 110C and 110D that each extend upward from the supporting surface to the beam assembly 200. The material utilized to form the legs 110A, 110B, 110C, 110D may include, but is not limited to, wood, plastic, and metal (e.g., aluminum or steel), etc. Similarly, the size and shape of the legs 110A, 110B, 110C, 110D is not limited to that illustrated herein, and may include round, oblate, and square cross sections. The bottom end of each leg 110A, 110B, 110C, 110D may further include a foot 120 to further stabilize the workbench 10 and prevent its sliding along the supporting surface. The foot 120 may be made from materials such as elastomeric materials, a plastics, and/or rubber.

In the embodiment illustrated, the beam assembly 200 comprises a first rail 215 and a second rail 225 spaced in parallel and extending from the first bracket 300A to the second bracket 300B. The materials utilized to form rails 215, 225 is not limited, and may include plastic, wood, and metal (e.g., steel or aluminum), etc. The size (length or diameter) and shape of the rails 215, 225 is not limited to that illustrated herein. By way of example, the rails 215, 225 may have a square, round, or oblate cross section. The beam assembly 200 may also include a handle 250 connected to a handle support 255 comprising a bar secured between the proximate the center of the rails 215, 225.

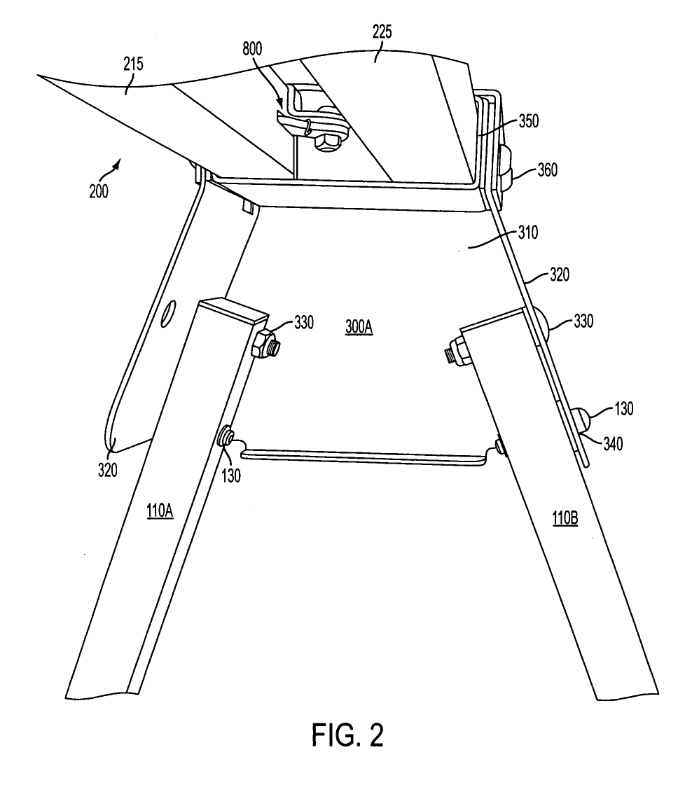

Each pair of legs 110A, 110B and 110C, 110D may be coupled to the beam assembly 200 utilizing a bracket 300. Specifically, the first pair of legs 110A, 110B may be coupled to a first bracket 300A and the second pair of legs 110C, 110D may be coupled to a second bracket 300B. FIG. 2 is a close-up view of the underside of the beam assembly 200, showing the first bracket 300A coupling the first pair of legs 110A, 110B to the beam assembly 200. As illustrated, the bracket 300A may comprise a central portion or wall 310 and a side portions or walls 320 extending from each edge of the central wall 310 (toward the beam assembly 200). The beam assembly 200 may be secured to the bracket 300A via a bracket receptacle or pocket 350. The pocket 350 receives the support beam assembly 200, which may be secured therein by means of pocket fasteners 360. The material utilized to form the bracket 300A is not limited, and may include plastic, wood, and metal (e.g., aluminum or steel), etc. Though only the first bracket 300A is illustrated in FIG. 2, a similar structure is provided for the second bracket 300B.

The first pair of legs 110A, 110B may be secured to the bracket side walls 320 using leg fasteners 330. The leg fasteners 330 may include, but are not limited to, screws, bolts, etc. As illustrated in FIG. 2, the first bracket 300A may connect to the legs 110A, 110B utilizing fasteners that extend through the side portions 320 of the bracket 300A and engage threaded nuts disposed on the each leg 110A, 110B. In addition, the legs 110A, 110B may be configured to pivot with respect to the bracket 300A. Referring the FIG. 2, the leg fastener 330 coupling each leg 110A, 110B to the bracket side wall 320 may permit the rotation of the legs about the fastener. Consequently, each leg 110A, 110B may be operable to pivot from a first position, in which the leg is substantially perpendicular to the beam assembly 200, to a second position, in which the leg is substantially parallel to the beam assembly 200 (discussed in greater detail below). The legs 110A, 110B may be secured in the first or second positions using a detent mechanism. Many types of detent mechanisms are known and utilized in the prior art. Two such mechanisms may be found in U.S. Pat. Nos. 4,605,099 and 5,592,981, both of which are hereby incorporated by reference in their entireties. In the embodiment of FIG. 2, each leg 110A, 110B includes a detent pin 130 configured to align with one or more apertures 340, 345 positioned on the side portions 320 of the bracket 300A. The detent pin 130 is spring-biased toward engagement with the apertures 340, 345.

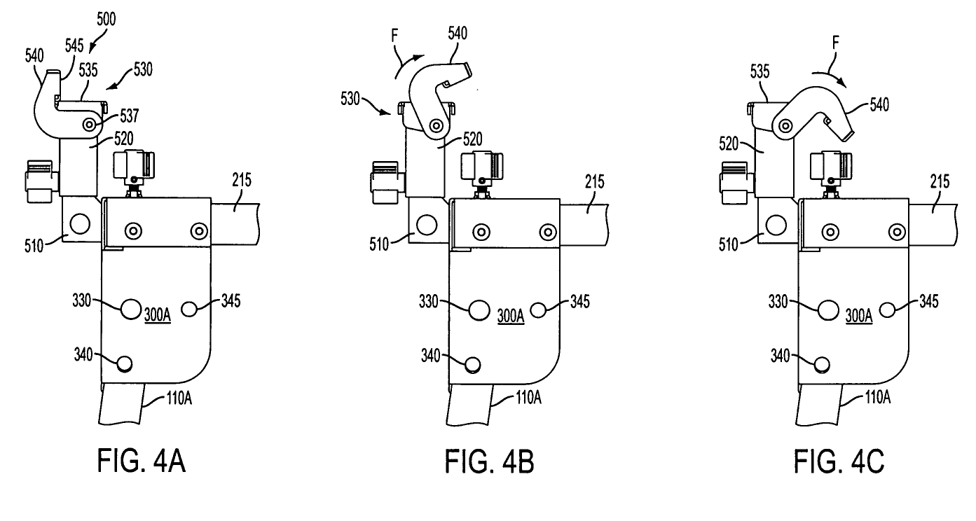

With this configuration, the legs 110A,110B can be folded inward, toward the beam assembly 200 to place the workbench 10 in a compact/folded configuration. In operation, with a leg 110A, 110B beginning in its first, deployed position (where the leg is substantially perpendicular to the beam assembly 200), the detent pin 130 is axially urged into the leg 110A, 110B until it clears a first aperture 340 (seen best in FIG. 4A). The leg 110A, 110B, now released, can be pivoted about the leg fastener 330 away from the central wall 310 of the bracket 300A. The leg 110A, 110B can be moved until the detent pin 130 aligns with a second aperture 345. Once aligned, the pin 130 is urged through the aperture (due to the outward spring bias of the pin 130), securing the leg 110A, 110B and preventing its further rotation. In this manner, the leg 110A, 110B is now oriented in its second, storage position (wherein the leg is substantially parallel to the beam assembly 200). To return the leg 110A, 110B to its deployed position, the reverse of the above process is followed, with the detent pin 130 being pushed inward until it clears the second aperture 345, and the leg being rotated toward the center wall 310 of the bracket 300A until the pin becomes aligned with the first aperture 340. A similar process may be followed to reorient the second pair of legs 110C, 110D connected to the second bracket 300B.

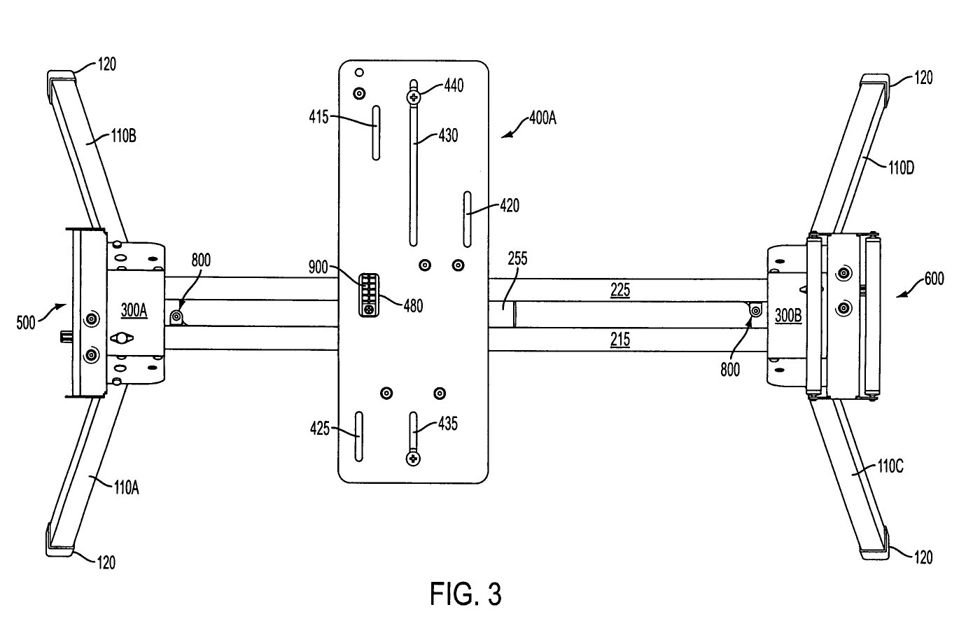

The beam assembly 200 comprises a structure adapted to support at least one tool support platform 400. FIG. 3 is a top view of the workbench 10 of FIG. 1. As referenced above, the beam assembly 200 comprises a first rail 215 and a second rail 225 spaced in parallel and extending from the first bracket 300A to the second bracket 300B. The beam assembly 200 may further include one or more workpiece support assemblies. Referring back to the embodiment illustrated in FIG. 1, the first rail 215 includes a first workpiece support assembly 500 (proximate first bracket 300A) and the second rail 225 includes a second workpiece support assembly 600 (proximate the second bracket 300B). The workpiece support assemblies 500,600 may be made of materials including, but not limited to, wood, plastic, and metal (e.g., steel or aluminum), etc. The workpiece support assemblies 500, 600 are configured to support the workpiece on which the tool is acting. For example, the workpiece may comprise a length of wood being cut by a power tool such as a miter saw.

FIGS. 4A, 4B, and 4C are close-up views of the first bracket 300A, showing the first workpiece support assembly 500 connected to the beam assembly 200. As shown, the first workpiece support assembly 500 may include a post 510, a middle body 520, and an upper body 530. The upper body 530 may comprise a workpiece support surface 535 that is configured to support the workpiece. Preferably, the workpiece support surface 535 is substantially horizontal. A stop member 540 may be pivotally attached to upper body 530 (at pivot point 537) using conventional fasteners (such as screws, bolts, etc.). The stop member 540 may comprise a substantially planar end 545 operable to engage the workpiece (e.g., the end of a board). With this configuration, and as illustrated in FIGS. 4A, 4B, and 4C, the stop member 540 can pivot from a first position, in which the end 545 is substantially vertical and positioned over the support surface 535 of the upper body 530 (as illustrated in FIG. 4A); to a second position, in which the end 545 is generally positioned below the support surface 535 of the upper body 530 (as illustrated in FIG. 4C). In the first position (illustrated in FIG. 4A), the workpiece engages both the support surface 535 and the end 545 of the stop member 540; consequently, the stop member 545 prevents the workpiece from traveling beyond the first workpiece support assembly 500 (i.e., the stop member end 545 faces the tool mounted on the workbench 10 so that the stop member end 545 can contact the workpiece and act as a stop). In the second position (illustrated in FIG. 4C), the stop member 540 does not engage the workpiece, permitting the workpiece to travel beyond the support assembly 500 (i.e., the stop member 540 is effectively bypassed so that the workpiece contacts only support surface 535 of the stop member 540).

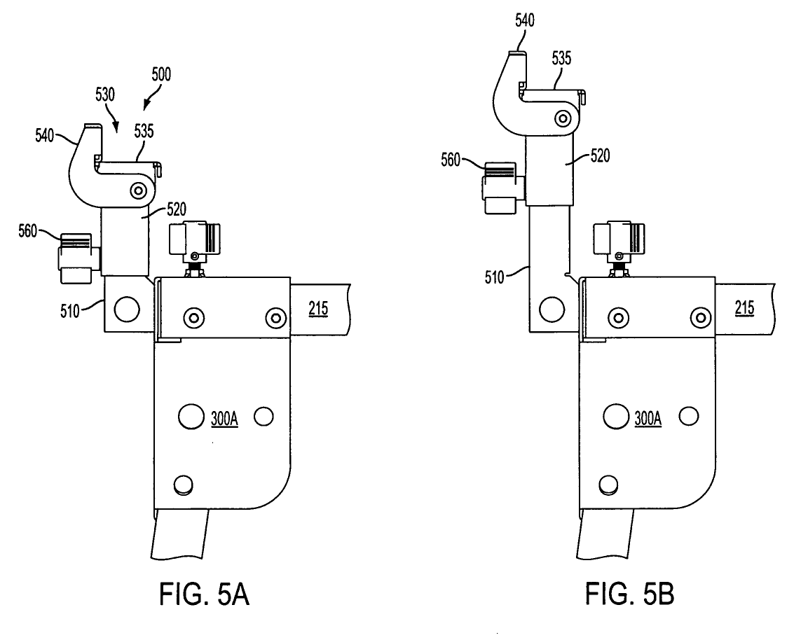

In addition, the height of the first workpiece support assembly 500 may be adjusted to accommodate workpieces of various sizes, as well as to accommodate tools of various dimensions. Specifically, the middle body 520 may be configured to slide upward to adjust the overall height of the support surface 535. The post 510 and middle body 520 may each include a generally vertical slot (not shown). Each slot is aligned and selectively secured by a fastener (e.g., a screw/bolt) controlled by a knob 560. In operation, the knob 560 can be engaged (e.g., by turning it counterclockwise) to loosen the fastener. This, in turn, permits the vertical movement of the middle body 520 with respect to the post 510. Consequently, as shown in FIGS. 5A and 5B, the first workpiece support assembly 500 may move from a first, compact position (as illustrated in FIG. 5A), to a second, expanded position (as illustrated in FIG. 5B). The knob 560 may again be engaged to tighten the fastener and secure the body 520 to the post 510 in the expanded position. The workpiece support assembly 5 may be secured at any desired expanded/compact position, thus permitting a user to adjust the height at which a workpiece is supported on the workpiece support assembly 500 above the beam assembly 200.

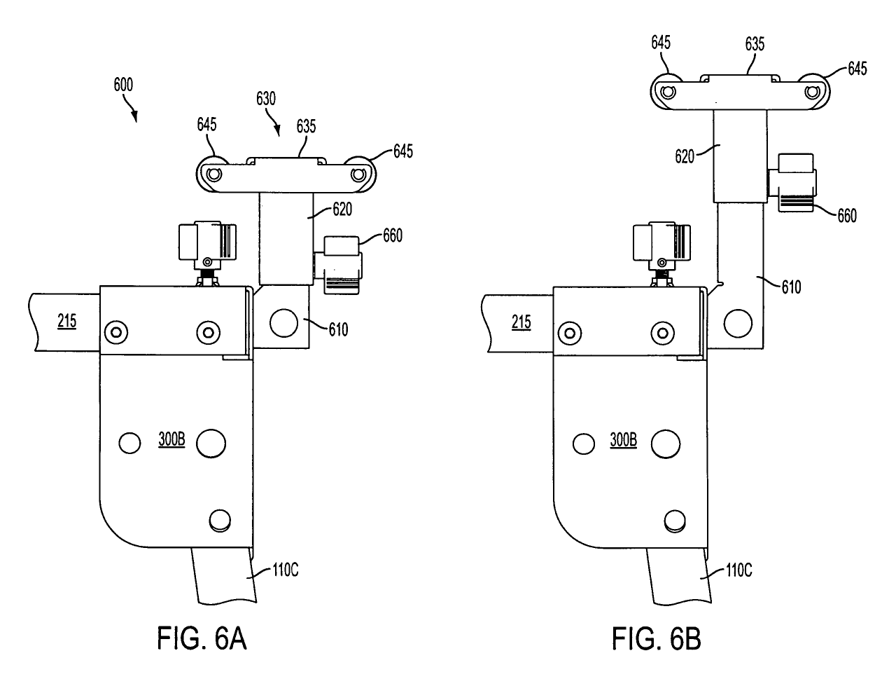

Referring to FIGS. 6A and 6B, the second workpiece support assembly 600 may be located proximate the second bracket 300B. Similar to the first workpiece support assembly 500, the second workpiece support assembly 600 may include a post 610, a middle body 620, and an upper body 630. The upper body 630 includes a support surface 635 and a pair of rollers 645 within the same plane as the support surface 635. The rollers 645 permit the rolling engagement of the workpiece over the supporting surface 635. The height of the second workpiece support assembly 600 may be adjusted in a similar manner to that explained above for the first workpiece support assembly 5. Briefly, engaging a knob 660 releases a fastener, permitting the middle body 620 to slide upward with respect to the post 610. In this manner, the second workpiece assembly 600 can be reoriented from a first, compact position (as illustrated in FIG. 6A) to a second, expanded position (as illustrated in FIG. 6B).

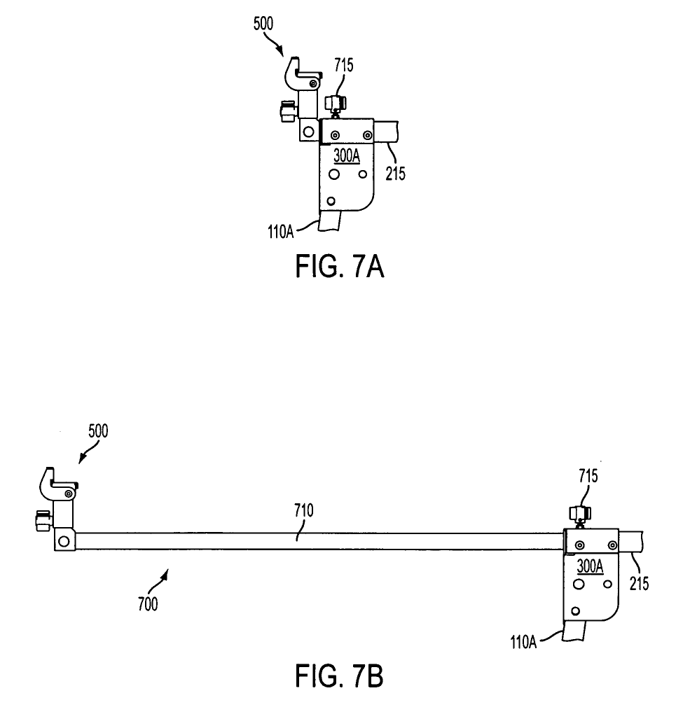

The workbench 10 of the present invention may be further adapted to permit the outward extension of the rails 215, 225 beyond the brackets 300. Specifically the workbench 10 may include one or more extension arm assemblies adapted to increase the overall length of the beam assembly 200. One suitable extension arm assembly is disclosed in U.S. Pat. No. 6,745,804 B2 (Welsh et al.), which is incorporated by reference herein in its entirety. Briefly, each rail 215, 225 may include a channel extending partially or completely along the length of the rail 215, 225. The channels receive an extension arm that telescopes into and out of its respective channel. FIGS. 7A and 7B illustrate perspective, close-up views of the first workpiece support assembly 500. The first workpiece support assembly 500 may be connected (via, e.g., fasteners such as screws, bolts, etc.) to a first extension arm 710 contoured to slidingly engage a channel within the first rail 215 of the beam assembly 2 (the bracket 300A includes an opening through which the extension arm 710 enters the channel). Consequently, the first workpiece support assembly 500 may be moved from a first, retracted position, in which the extension arm 710 is substantially housed within the channel of the rail 215 and first workpiece support assembly 500 and is positioned proximate the first bracket 300A (as illustrated in FIG. 7A); to a second, extended position, in which the extension arm 710 is at least partially removed from the channel of the first rail 215 and the first workpiece support assembly 500 is positioned remote from the first bracket 3A (as illustrated in FIG. 7B). The material used to form the first extension arm 710 is not limited, and may include wood, plastic, composite material, metal (e.g., steel or aluminum), etc.

The extension arm 710 may be secured at any desired degree of extension using a locking mechanism 715 including a fastener controlled by a gripping member. The fastener utilized in the locking mechanism 715 including may include, but is not limited to, screws, bolts, etc. Specifically, a threaded screw may engage an aperture in the top of the first bracket 300A such that rotating the gripping member of the locking mechanism 715 clockwise extends the screw into the channel, causing it to engage the first extension member 710 and prevent its axial movement within the channel of the first rail 215. Conversely, when the gripping member of the locking mechanism 715 is rotated counterclockwise, it disengages the first extension arm 710, permitting its axial movement into and out of the channel of the first rail 215.

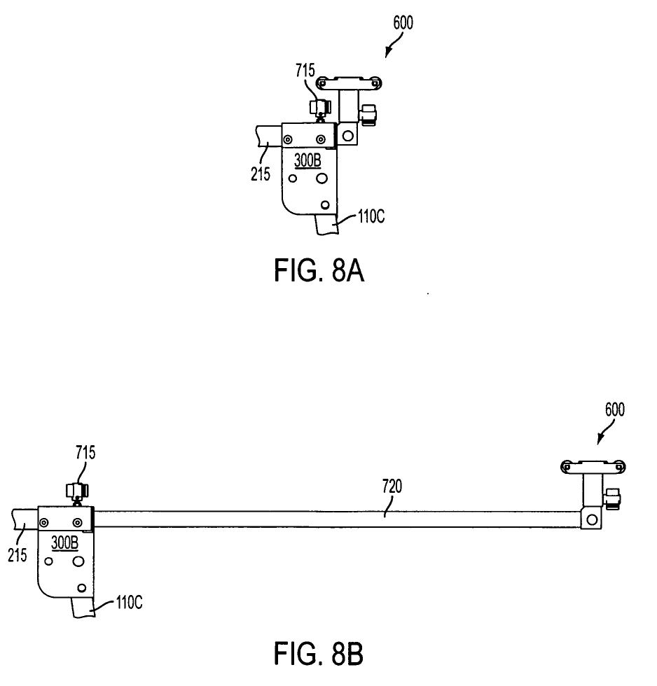

The second workpiece support assembly 600 may also be adapted to move with respect to the beam assembly 200 and/or second bracket 300B. FIGS. 8A and 8B illustrate perspective, close-up views of the second workpiece support assembly 600. As illustrated, the second support assembly 600 may connect (via, e.g., fasteners such as screws, bolts, etc.) to a second extension arm 720 contoured to slidingly engage a channel within the second rail 225 (note that the second rail 225 is located directly behind the first rail 215 in this view). The second bracket 300B includes an opening through which the extension arm 720 enters the channel in the second rail 225. Consequently, the second workpiece support assembly 600 may be moved from a first, retracted position, in which the second extension arm 720 is substantially housed within the channel in the second rail 225 and the second workpiece support assembly 6 is positioned proximate the second bracket 300B (as illustrated in FIG. 8A); to a second, extended position, in which the second extension arm 720 is at least partially removed from the channel in the second rail 225 and the workpiece support assembly 6 is positioned remote from the second bracket 300B (as illustrated in FIG. 8B). As with the first extension arm 710, the second extension arm 720 may also be secured at a desired degree of extension using a locking mechanism 715 comprising a fastener controlled by a gripping member. The fastener may include, but is not limited to, screws, bolts, etc. Specifically, a threaded screw may engage an aperture along the top of the second bracket 300B such that rotating the gripping member of the locking mechanism 715 clockwise extends the screw into the channel of the second rail 225, causing the screw to engage the second extension arm 720 and prevent its axial movement within the channel of the second rail 225. When the gripping member of the locking mechanism 715 is rotated counterclockwise, the screw disengages the second extension arm 720, permitting its axial movement into and out of the channel of the second rail 225. Additional locking mechanisms are disclosed in the above-incorporated '804 patent to Welsh et al. As with the first extension arm 710, the material used to form the second extension arm 720 is not limited, and may include wood, plastic, composite material, metal (e.g., steel or aluminum), etc.

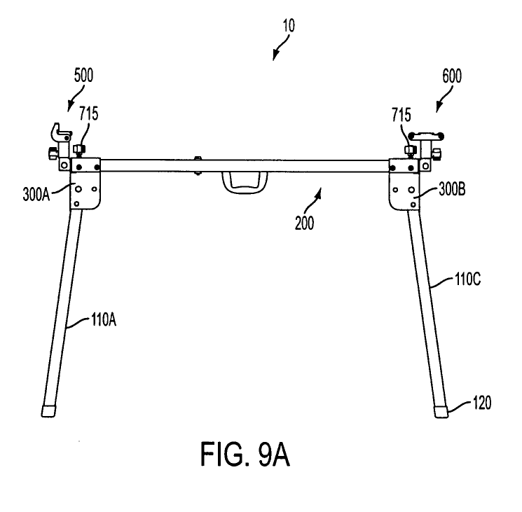

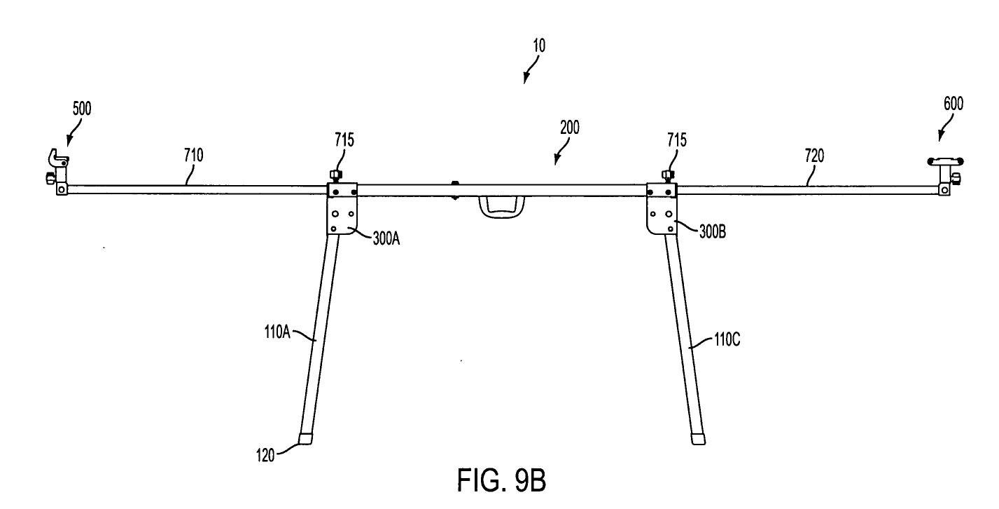

With the above described configuration, each extension arm 710, 720 may be independently extended and retracted into and out of the beam assembly 200 (and, in particular, into and out of its respective rail 215, 225) to alter the distance between the workpiece support assembly 500, 600 and its corresponding bracket 300A, 300B. FIGS. 9A and 9B illustrate front views of the workbench 10. As shown, the distance between the workpiece support assemblies 500,600 and the beam assembly 200 (and thus the tool attached to the workbench 10) may be reoriented from a retracted configuration to an extended configuration. This reorientation accommodates workpieces or various sizes-the extension arms 710,720, since they slide out horizontally from both ends of the beam assembly 200, may provide the user with an adjustable work area for workpieces such as long trim, decking boards, and dimensional framing material.

The length of the extension arms 710, 720 is not limited to that illustrated herein. By way of specific example, if the combined length of beam assembly 200 and brackets 300A, 300B (with extension arms 710, 720 retracted) is A, the length of each extension arm 710, 720 is preferably more than half of length A. Thus, when both extension arms 710, 720 are expanded, the total length of the beam assembly 200 and the brackets 300A, 300B would be at least more than twice the length of A. Persons skilled in the art will recognize that, if the lengths of extension arms 710, 720 are maximized for maximum length without being longer than the beam assembly 200, the total length A will typically measure between about 2 to 3 times the length of A.

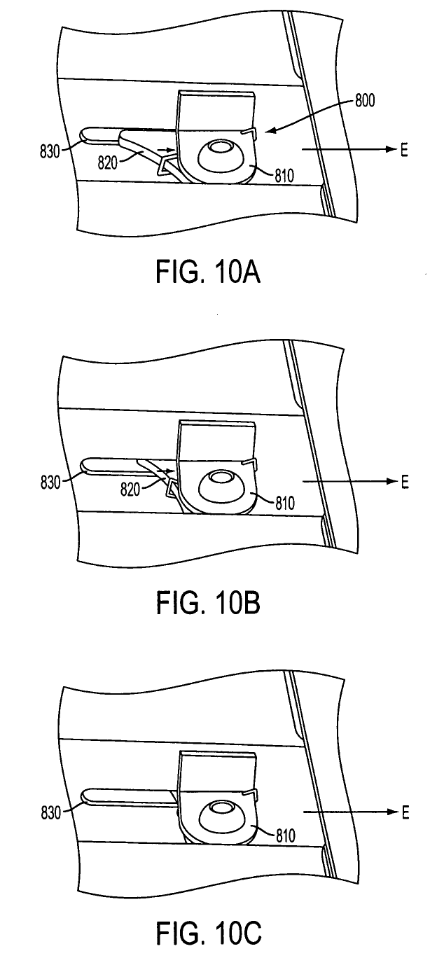

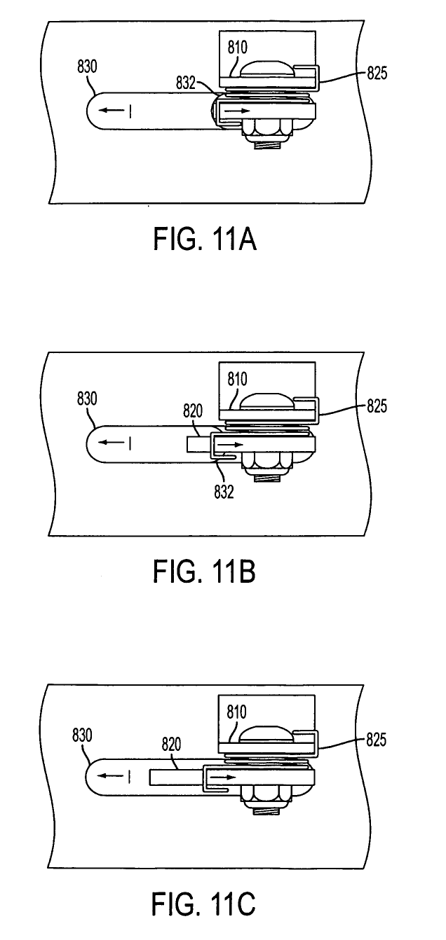

As mentioned above, each rail 215, 225 may include a catch mechanism 800 to prevent the complete removal of an extension arm 710, 720 from its respective rail 215, 225. The catch mechanisms 800 are typically positioned along a rail 215, 225 proximate the bracket 300A, 300B (best seen in FIGS. 2 and 3). FIGS. 10 and 11 illustrate close-up views of a catch mechanism 800 according to an embodiment of the invention. The catch mechanism 800 may include base 810 with a lever 820 biased via a spring 825 (best seen in FIG. 11A). The spring loaded lever 820 aligns with a slot 830 located on each rail 215, 225. In addition, each of the first and second extension arms 710, 720 includes a slot located near its end (opposite their respective workpiece support assemblies 500, 600 (see 832 in FIGS. 11A and 11B)). The extension arm slot 832 is configured to align with the rail slot 830 when it obtains a predetermined extension position. While the slots are misaligned, the lever 820 maintains its normal, disengaged position as illustrated in FIG. 10A. As the extension arm 710, 720 is axially removed from the channel of the rail 215, 225 (as illustrated by arrow E in FIGS. 10A-C), the extension arm slot eventually aligns with the rail slot 830. The lever 820, which is spring biased toward the extension arm 710, 720, passes through the rail slot 830 (FIG. 10B) and into the extension arm slot (FIG. 10C). The lever 820 may be configured to stop rotating once it becomes perpendicular with respect to the extension arm 710, 720. In this position, the lever 820 catches the extension arm 710, 720 to prevent further removal of the extension arm from the channel (along the direction of arrow E), securing the extension arm within the rail 215, 225.

Though preventing the axial removal of the extension arm 710, 720 from the rail 215, 225, the catch mechanism 8 still permits the axial insertion of the extension arm 710, 720 into the rail 215, 225. Referring to FIGS. 11A, 11B, and 11C, as the extension arm 710, 720 is moved inward (toward the bracket 300A, 300B), the lever 820 can be forced out of the extension arm slot when an appropriate level of force is applied. Consequently, as the extension arm 710, 720 is axially inserted into the channel of the rail 215, 225 (in the direction of arrow I in FIGS. 11A-11C), the extension arm 710, 720 engages the lever 820 (FIG. 11B), pushing it outward and to rotating it away from the extension arm 710, 720 (shown by arrow R). Once the slot of the extension arm 832 travels past the rail slot 830 (i.e., once the slots are misaligned as shown in FIG. 11C), the lever 820 disengages the extension arm 710, 720, and the axial movement of the extension arm 710, 720 into and out of the channel of the rail 215, 225 is permitted.

The tool support platform 400 (also called a mounting platform) includes a structure configured to slidably engage the beam assembly 200, as well as to couple with a tool (not shown) having connection points (e.g., bolt apertures). Referring back to FIG. 1, the workbench 10 of the present invention includes a first tool support platform 400A and a second tool support platform 400B, each configured to support a portion of the tool. The tool support platforms 400A, 400B may mount onto the beam assembly 200 by engaging the top and/or outside of rails 215, 225 (discussed in greater detail below). Alternatively, the tool support platforms 400A, 400B could engage the insides of rails 215, 225 (not shown). The size and shape of the tool support platform 400A, 400B is not limited to that illustrated herein and may include various geometric shapes (e.g., rectangles, squares, etc.).

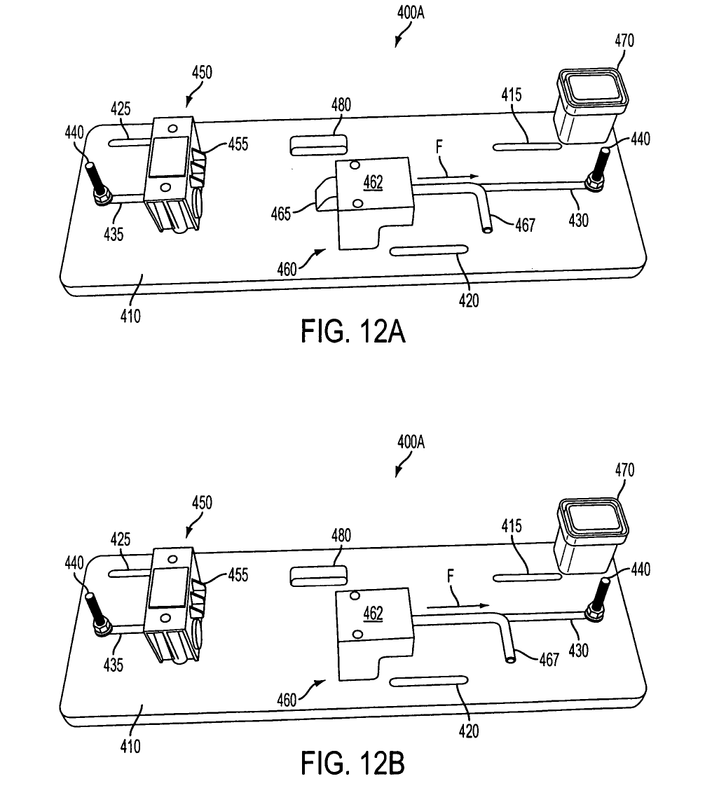

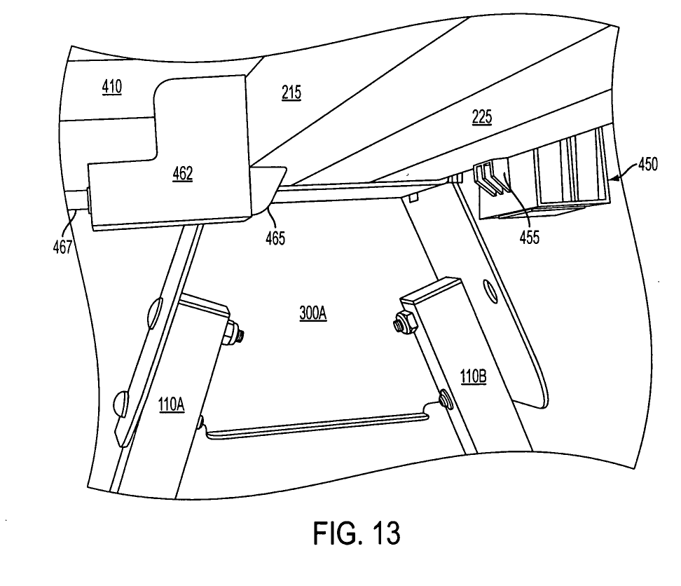

FIGS. 12A and 12B are isolated, perspective views of the bottom surface of a tool support platform 400A according to an embodiment of the invention. It should be understood that although only the first tool support platform 400A is illustrated, the second tool support platform 400B may comprise a substantially similar structure (e.g., the second tool support platform 400B may form a mirror image of the first tool support platform 400A). As illustrated, the first tool support platform 400A may comprise a body 410 including at least one mounting slot. The material utilized to form the body 410 is not limited and may include, but is not limited to, wood, composite material, metal, plastic, etc. Similarly, the number and/or placement of the mounting slots is not limited to that illustrated herein. In the embodiment illustrated in FIG. 12A, the body 410 includes five mounting slots 415, 420, 425, 430, 435 having generally elongated shapes. Mounting slots 415, 420, and 425 may be located proximate the peripheral edges of the body 410, while slots 430, 435 may be placed proximate the longitudinal center of the body 410. The body 410 may further include a receptacle 480 that engages a stabilizer member positioned on the beam assembly 200 to prevent the tool support platform 400A from sliding along the beam assembly 200 (as discussed in greater detail below).

The tool may be attached to the tool support platform 400A, 400B using one or more fasteners. By way of example, a bolt may extend through a slot 415, 420, 425, 430, 435 and into corresponding connection aperture in the tool. The number of fasteners and/or slots engaged by the fasteners is not limited to that illustrated herein, and typically would depend on the connection requirements of a specific tool (i.e., on the particular connection layout of a particular manufacturer). Thus, although the fasteners 440 are shown in FIGS. 12A and 12B to engage slots 430 and 435, the fasteners 440 may alternatively engage other or additional slots (e.g., slots 415, 420, and/or 425). With this configuration, each slot 415, 420, 425, 430, 435 may selectively be used to provide a connection point for a tool adapted for the particular aperture configuration (i.e., the layout and number of fastener apertures) of the tool.

Additionally, each fastener 440 may move within each slot 415, 420, 425,430, 435 so that the position of the fastener 440 may be adjusted with respect to the tool (and, specifically, the connection point of the tool). For example, as shown in the embodiment illustrated in FIGS. 12A and 12B, each slot 415, 420, 425, 430, 435 is elongated; consequently, each fastener 440 may be repositioned within the slot, moving from a first position to a second position and vice versa. This permits the alignment of the fastener 440 with a corresponding connection point of the tool to be mounted to the tool support platform 400A.

The tool support platform 400A, 400B further includes a mounting bracket operable to engage the rails 215, 225 and slidingly secure the platform 400A, 400B to the beam assembly 200. The mounting bracket may include a glide member 450 and a lever 460. Preferably, both the glide member 450 and the lever 460 are made of plastic, such as nylon. The glide member 450 and the lever 460 may be attached to the body 410 of the tool support platform 400A using conventional fasteners. The glide member 450 includes a ledge 455 configured to engage a rail 215, 225 of the beam assembly 200 (e.g., the bottom face of a rail (as discussed in greater detail below)). The lever 460 includes a housing 462 and a spring loaded tab or tongue 465 that extends from the housing (see FIG. 12A). The tab 465 is configured to engage a rail 215, 225 of the beam assembly 200 (e.g., the bottom face of the rail). The tab 465 is coupled to a handle 467, and both are biased toward the glide member 450 (and thus the rail). The tab 465, moreover, may be retracted into the lever housing 462 by engaging the handle 467 and drawing it away from the glide member 450. In operation, the handle 467 begins in its normal, biased position (FIG. 12A). When a pulling force (indicated by arrow F) is applied to the handle 467, the tab 465 is retracted into the housing 462 (as illustrated in FIG. 12B).

With such construction, the user can easily mount the tool support platforms 400A, 400B onto, and remove the platforms from, the beam assembly 200. FIG. 13 illustrates a close-up view of the workbench 10 of the present invention, showing the coupling of the first tool support platform 400A to the beam assembly 200. In operation, the tab 465 is retracted as explained above. The glide member 450 and the lever 460 are aligned with the second 225 and first 215 rails, respectively. The first tool support platform 400A is urged downward such that the glide member 450 is positioned proximate the outer surface of the second rail 225 such that the ledge 455 engages the bottom surface of the rail 225. In addition, the lever 460 is positioned proximate the outer surface of the first rail 215. The user may then release the handle 467, causing the spring-biased tab 465 to return to its normal (extended) position and engage the bottom surface of the first rail 215. The engagement of the ledge 455 and the tab 465 slidingly capture the first tool support platform 400A onto the beam assembly 200 (thus, the tool support platform 400A is able to freely slide along the beam assembly 200). In a similar manner, the second tool support platform 400B (not shown) may be mounted on the beam assembly 200. To remove the tool support platforms 400A, 400B (and thus the tool mounted thereto) from beam assembly 200, the user needs only to engage the handle 467, retract the tab 465, and lift the tool support platforms 400A, 400B from the beam assembly 200. It is important to note that the tool is typically coupled to the tool support platforms 400A, 400B prior to mounting the platforms on the beam 200; consequently, the above configuration provides a simple mechanism by which a tool may be connected to and removed from the workbench 10.

The tool support platform 400A, 440B may further be configured to stand on a supporting surface such as a table, the floor, or the ground. Each of the glide member 450 and the lever 460 are configured to function as a support. In addition, as shown in FIGS. 12A and 12B, the platform 400A, 400B may further include a foot 470 configured to cooperate with the glide member 450 and the lever 460 in supporting the tool support platform 400A, 400B on a supporting surface (such as a table, the floor, or the ground). That is each of the glide member 450, lever 460, and the foot 470 are substantially the same height, providing a plurality of foot members that support the tool support platform 400A, 400B on a supporting surface. With this configuration, a user can remove the tool support platforms 400A, 400B (with the tool still connected) from the workbench 10 and place the tool/platforms onto a supporting surface. The glide member 450, lever 460, and the foot 470 may each include or be form from a rubber or other elastomeric material, and may be attached to the body 410 via fasteners such as bolts.

The workbench 10 of the present invention may further include a locking mechanism to prevent the sliding of the too support platforms 400A, 400B along the beam assembly 200. Referring back to FIG. 3, a stabilizer member 900 may be provided. The stabilizer member 900 may comprise a substantially U-shaped clamp that may be selectively secured to a rail 215, 225 of the beam assembly 200. The surface of the stabilizer member 900 facing upward (toward the platform/tool) may include a protrusion that is received by the receptacle located 480 in the body 410 of the tool support platform 400. The protrusion may be sized and shaped such that it prevents the lateral movement of the tool support platform 400 along its respective rail 215, 225. In operation, a user secures the clamp 900 to a rail 215, 225. When mounting the tool support platform 400 onto the beam assembly 200, the receptacle 480 in the tool support platform 400 is aligned with the clamp 900 so that the protrusion is received within receptacle 480. The tab 465 is released as explained above to secure the tool support platform 400 to the beam assembly 200. With the protrusion of the stabilizer member 900 positioned within the receptacle 480 of the tool support platform 400, the tool support platform 400 is stabilized and the lateral movement of the platform along the beam assembly 200 is prevented.

While the invention has been described in detail and with reference to specific embodiments thereof, it will be apparent to one skilled in the art that various changes and modifications can be made therein without departing from the spirit and scope thereof. For example, the workbench 10 can be of any size and shape, and may be formed from any suitable materials. The brackets 300A, 300B may be of any size and shape suitable to connect the beam assembly 200 to the base 100. The degree of rotation of the legs 110A, 110B, 110C, 110D with respect to the beam assembly 200 is not limited to that illustrated herein. Any number of apertures may be provided in the brackets 300A, 300B to secure the legs 110A, 110B, 110C, 110D at various desired angles. The tool support platforms 400A, 400B may be any size and shape and may comprise any suitable materials. The tool support platforms 400A, 400B may connect with any tool having a connection point layout. Although designed to support a miter saw and a workpiece (not shown), the tool support platforms 400A, 400B may be used to support any tool, such as a chop saw, a drill press, a table saw, etc., any hand tools, or anything else that may need to be supported. Any number of foot members may be provided on the tool support platforms 400A, 400B. The size and shape of the receptacle 480 in the tool support platforms 400A, 400B is not limited to that which is illustrated herein. The receptacle 480 may extend partly or completely through the platform body 410. Similarly, the size and shape of the stabilizer member 900 is not limited to that which is illustrated herein.

Thus, it is intended that the present invention cover the modifications and variations of this invention that come within the scope of the appended claims and their equivalents. For example, it is to be understood that terms such as “left”, “right” “top”, “bottom”, “front”, “rear”, “side”, “height”, “length”, “width”, “upper”, “lower”, “interior”, “exterior”, “inner”, “outer” and the like as may be used herein, merely describe points of reference and do not limit the present invention to any particular orientation or configuration.

We claim:

1. A support device for a tool comprising:
a beam;
a base configured to support the beam over a supporting surface;
at least one tool support platform adapted to connect to the beam such that it is capable of moving from a first beam position to a second beam position and vice versa; and
at least one protrusion extending from the beam;
wherein the tool support platform further includes a receptacle configured to receive the protrusion, and the protrusion is operable to secure the tool support platform in the first beam position or the second beam position.

2. The support device for a tool of claim 1, wherein the protrusion extends toward the tool support platform.

3. The support device for a tool of claim 1, wherein the tool support platform is removably connected to the beam.

4. The support device for a tool of claim 1, wherein the tool support platform is slidingly connected to the beam.

5. The support device for a tool of claim 1, wherein the protrusion comprises a repositionable fastener secured to the beam.

6. A support device for a tool comprising:
a base;
a beam supported over a supporting surface by the base;
at least one tool support platform including:
a body,
a first foot member, and
a second foot member opposing the first foot member,
wherein the tool support platform may be oriented in a first position, in which the first and second foot members support the platform on the supporting surface, and a second position, in which the foot members slidably attach the platform to the beam.

7. The support device for a tool of claim 6, wherein the first foot member includes a boss operable to move from an extended, beam-capturing position, to a retracted, beam-releasing position, and vice versa.

8. The support device for a tool of claim 7, wherein the boss is spring biased in the extended, beam-capturing position, and the first foot member further includes an actuator operable to move the boss from the extended, beam-capturing position to the retracted, beam-releasing position.

9. The support device for a tool of claim 6, wherein the second foot member includes a ledge operable to capture the beam.

10. The support device for a tool of claim 6, wherein the tool support platform further includes a third foot member operable to support the tool support platform on the supporting surface.

11. A support device for a tool comprising:
a beam;
a base configured to support the beam over a supporting surface;
at least one tool support platform adapted to slidably connect to the beam;
at least one fastener operable to couple to a tool to the tool support platform;
wherein the tool support platform comprises a first slot, a second slot, and a third slot, each slot adapted to receive the at least one fastener and enable the fastener to move within the slot from a first slot position to a second slot position and vice versa.

12. The support device for a tool of claim 11, wherein the tool support platform is removably connected to the beam.

13. A tool support platform for a support device including a beam, the tool support platform comprising:
a body;
a first foot member extending from the body; and
a second foot member opposing the first foot member;
wherein the first and second foot members are operable to slidingly capture the tool support platform to the beam, and wherein the first and second foot members are further capable of cooperating to support the tool support platform over supporting surface.

14. The tool support platform of claim 13, wherein the body further includes at least one slot configured to receive a fastener.

15. The tool support platform of claim 14, wherein the at least one slot permits the movement of the fastener within the slot from a first slot position to a second slot position and vice versa.

16. The tool support platform of claim 13, wherein the first foot member includes a boss operable to move from an extended, beam-capturing position, to a retracted, beam-releasing position, and vice versa.

17. The tool support platform of claim 16, wherein the boss is spring biased in the extended, beam-capturing position, and first foot member further includes an actuator operable to move the boss from the extended, beam-capturing position to the retracted, beam-releasing position.

18. The tool support platform of claim 13, wherein the second foot member includes a ledge operable to capture at least a portion of the beam.

19. The tool support platform of claim 13 further comprising a third foot member operable to support the platform on the supporting surface.
